(19) United States
(12) Patent Application Publication
(10) Pub. No.: US 2008/0295781 A1
(43) Pub. Date: Dec. 4, 2008

(54) Container device for bathing or swimming

(76) Inventor: Sherry Huang, Vancouver (CA)

Correspondence Address: CHARLES E. BAXLEY, ESQUIRE, 90 JOHN STREET, SUITE 309, NEW YORK, NY, 10038, US

(21) Appl. No.: 11/807,992

(22) Filed: May 30, 2007

(51) Int. Cl. A01K 29/00

(52) U.S. Cl. 119/673

(57) ABSTRACT

A container device includes a container having a chamber formed by an outer peripheral wall, and a flexible insert engaged into the container and having a compartment for receiving water and pets or users, and a piercing device may be used for selectively piercing the insert after use to allow the water to be discharged from the insert and the container. The piercing device includes a piercing member for piercing the insert and for engaging into a lower outlet mouth of the container and for allowing the water to be discharged from the insert after use, and for preventing the outlet mouth from being blocked by the hairs that are washed or removed from the pet cats and small dogs.

### BACKGROUND OF THE INVENTION

1. Field of the Invention

The present invention relates to a container device, and more particularly to a container device for bathing or swimming purposes and having an insert for easily cleaning purposes.

2. Description of the Prior Art

Typical container or bathing devices for pet cats and small dogs comprise a transparent cat bath dimensioned to receive the pet cats and small dogs and having a lower drain for discharging the water contained in the bath.

For example, U.S. Pat. No. 4,987,860 to Davis discloses one of the typical small animal baths comprising a transparent container, and a dip basket received in the container.

However, normally, water and washing agent are directly received or contained within the container such that the container may not be easily or quickly cleaned after bathing. In addition, many hairs may be washed or removed from the pet cats and small dogs, and the hairs may block the lower drain when the water is drained or discharged from the container.

U.S. Pat. No. 5,678,511 to Day discloses another typical bathing device for pets comprising a basin for receiving the pet cats and small dogs and having a lower drain for discharging the water contained in the bath.

However, similarly, the container also may not be easily or quickly cleaned after the bathing operations, and the lower drain may also be easily blocked by the hairs that are washed or removed from the pet cats and small dogs when or after the water is drained or discharged from the container.

The present invention has arisen to mitigate and/or obviate the afore-described disadvantages of the conventional container devices.

### SUMMARY OF THE INVENTION

The primary objective of the present invention is to provide a container device including an insert or inner flexible film or membrane or envelope for receiving the pet cats and small dogs and for bathing or swimming purposes and for allowing the insert or flexible film or membrane or envelope to be easily removed or to be easily and quickly cleaned.

The other objective of the present invention is to provide a container device including a piercing device for piercing the insert or flexible film or membrane or envelope after the bathing or swimming operations, and for allowing the water to be easily and quickly drained or discharged from the container, and for preventing the lower drain from being blocked by the hairs that are washed or removed from the pet cats and small dogs.

In accordance with one aspect of the invention, there is provided a container device comprising a container including a chamber formed therein and formed by an outer peripheral wall for receiving water therein, and including an outlet mouth, a flexible insert engaged into the chamber of the container and having a compartment formed therein, and a piercing device for selectively piercing the insert after use to allow the water to be discharged from the insert and the container.

The piercing device includes a piercing member for piercing the insert and for engaging into the mouth of the container and for allowing the water to be discharged from the insert after use. The piercing device includes a pipe attached to the piercing member for engaging with the mouth of the container.

The piercing device includes a casing attached to the pipe, and the casing includes a number of orifices formed therein for water discharging purposes. The piercing device includes at least one fin extended outwardly from the casing. The piercing device includes a partition provided between the casing and the pipe for engaging with the insert.

The container includes a valve device attached to the outlet mouth of the container to control the water to flow out through the outlet mouth of the container. The valve device includes am outlet tube attached to the outlet mouth of the container, and a valve member engaged in the outlet tube of the valve device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a container device in accordance with the present invention;

FIG. 2 is an exploded view of the container device;

FIG. 3 is a cross sectional view of the container device taken along lines 3-3 of FIG. 1;

FIG. 4 is an enlarged partial cross sectional view of the container device illustrating the operation of the container device;

FIG. 5 is an exploded and plan view illustrating a piercing device and a valve device for the container device; and

FIG. 6 is an exploded and cross sectional view taken along lines 6-6 of FIG. 5, illustrating the piercing device and the valve device for the container device.

### DETAILED DESCRIPTION OF THE PREFERRED EMBODIMENT

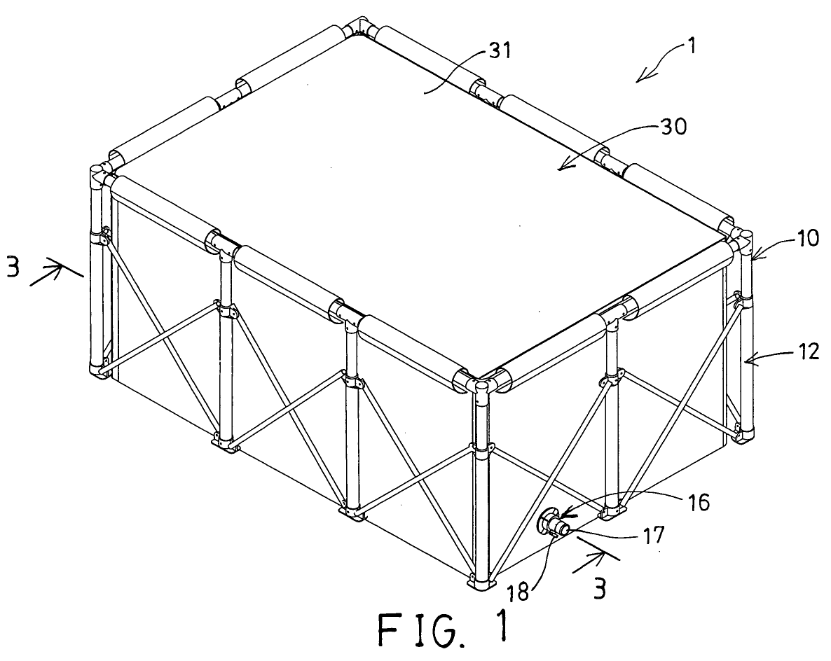

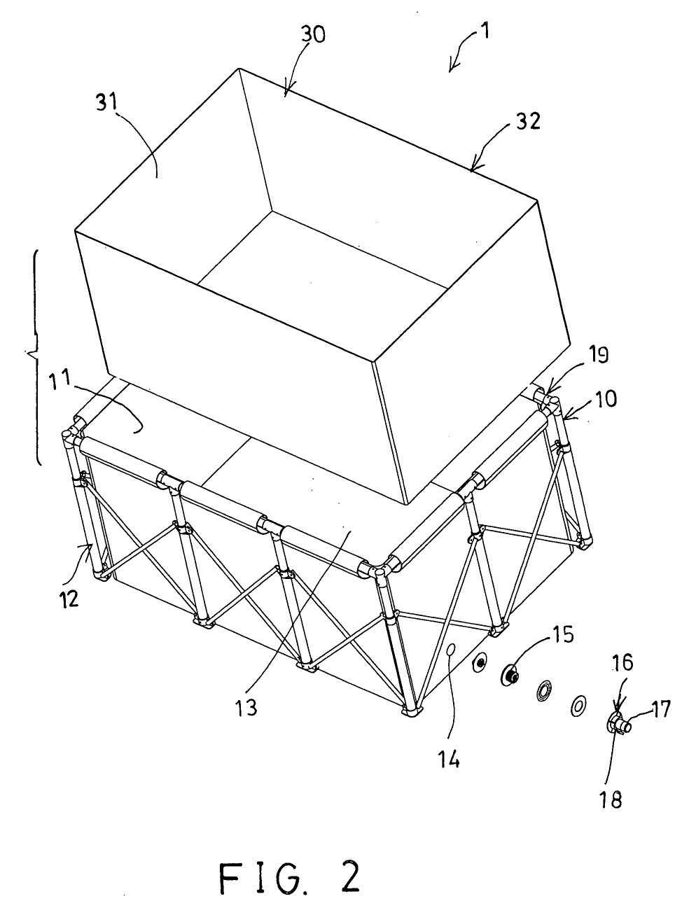

Referring to the drawings, and initially to FIGS. 1-3, a container device 1 in accordance with the present invention comprises a frame or container 10 including a chamber 11 formed therein and formed or defined by an outer peripheral wall 12 and/or a bottom wall 13. It is preferable that the container 10 includes a foldable structure for allowing the container 10 to be folded or received to a compact folding or receiving structure and for allowing the container 10 to be easily stored and transported. The container 10 includes an outlet opening 14 formed or provided in the lower portion thereof (FIG. 2) for receiving or attaching or engaging with an outlet port or mouth 15 which is preferably engaged within the container 10.

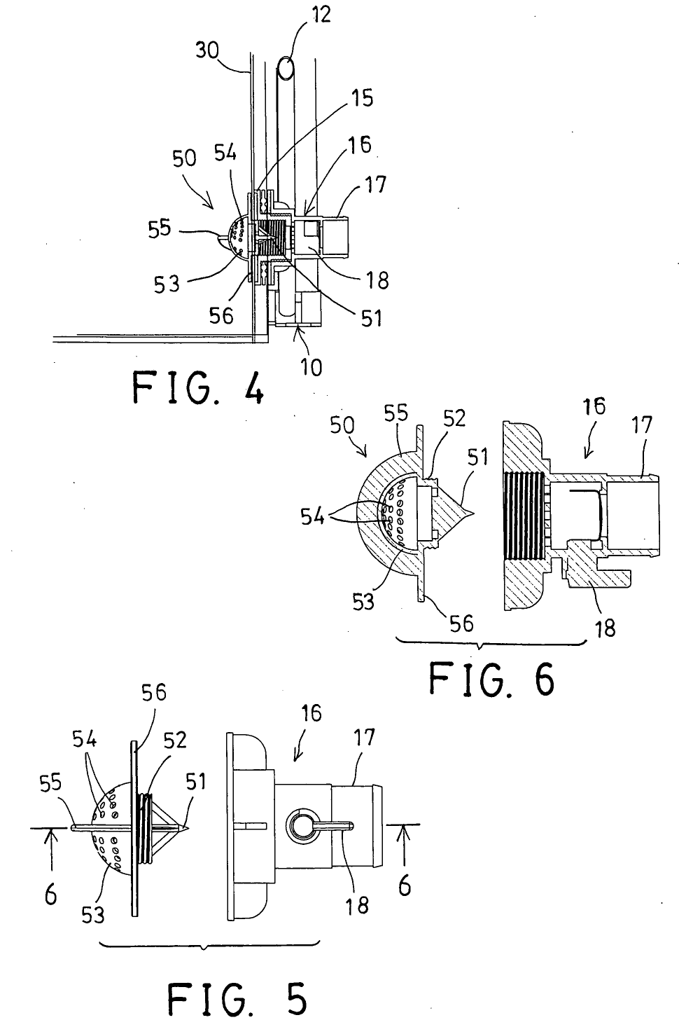

A valve device 16 is attached to the lower portion or the outlet opening 14 of the container 10 or to the port or mouth 15 of the container 10 and includes an outlet tube 17 attached onto the outer portion of the container 10 and secured to the port or mouth 15 of the container 10 with such as latches or fasteners (not shown) or with threading engagements or the like, and includes a valve member 18 engaged in the outlet tube 17 (FIGS. 4, 5) for controlling the water or fluid to flow out of the container 10. The container 10 further includes an inner flexible film or membrane or envelope or insert 30 engaged into the chamber 11 of the container 10 and having a compartment 31 formed therein for receiving the pet cats and small dogs or the users.

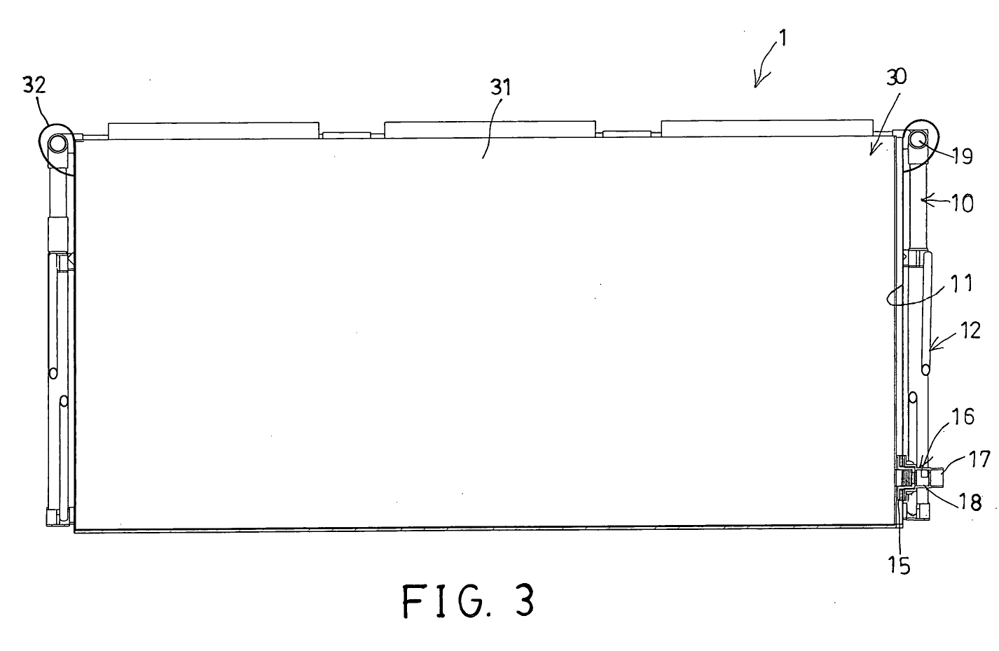

The insert 30 includes a water tight seal and preferably made of plastic or synthetic materials for receiving and containing the water or fluid therein and for bathing or swimming purposes. It is to be noted that the container 10 and the insert 30 may be formed or made into a great size or dimension or volume for receiving children and/or adults and/or the pet cats and small dogs and/or the other users simultaneously. It is preferable that the insert 30 includes an upper peripheral portion or flap 32 (FIG. 2) engaged over the upper portion 19 of the container 10 (FIG. 3) for suitably or solidly attaching or securing the insert 30 to the container 10 and for preventing the insert 30 from being collapsed.

In operation, the water may be received and contained in the compartment 31 of the insert 30, and the children and/or the adults and/or the pet cats and small dogs and/or the other users may also be engaged into the compartment 31 of the insert 30 for bathing or swimming purposes. It is to be noted that the flexible film or membrane or envelope or the insert 30 may be easily and quickly removed from the container 10 after use for allowing the container 10 to be easily and quickly cleaned after use. Both the insert 30 and the container 10 may be folded a compact folding or receiving structure for facilitating the storing and the transporting purposes for the container device 1.

As shown in FIGS. 4 and 5, the container device 1 further includes a piercing means or device 50 for selectively piercing the insert 30 after use or after the bathing or swimming operations, and for allowing the water to be easily and quickly drained or discharged from the insert 30 and/or the container 10. For example, the piercing device 50 includes a piercing member 51 attached to a threaded stud or pipe 52 for piercing the insert 30 and for engaging into the port or mouth 15 of the container 10 and/or the outlet tube 17 and for allowing the water to be easily and quickly drained or discharged from the insert 30 after use. The valve member 18 may be used to control the water or fluid to flow out through the outlet tube 17 of the container 10.

The piercing device 50 includes a substantially semi-spherical casing 53 having a number of orifices 54 formed therein for water draining or discharging purposes and also for shielding the hairs that are washed or removed from the pet cats and small dogs, and for preventing the lower drain or the port or mouth 15 of the container 10 and/or the outlet tube 17 from being blocked by the hairs that are washed or removed from the pet cats and small dogs. The piercing device 50 may further include one or more ears or fins 55 extended outwardly from the casing 53 for further shielding or stopping the hairs, and may further include a partition 56 formed or provided between the casing 53 and the threaded stud or pipe 52 for engaging with the insert 30 and/or the container 10 (FIG. 4).

In operation, as shown in FIG. 4, after use, the piercing member 51 of the piercing device 50 may pierce or engage through the insert 30 for allowing the water received and contained in the insert 30 and the container 10 to flow out through the pipe 52 of the piercing device 50 and the outlet tube 17 of the valve device 16, and the insert 30 may be easily and quickly removed from the container 10 for allowing the container 10 to be easily and quickly cleaned after use. In addition, the hairs that are washed or removed from the pet cats and small dogs may be shielded or blocked or stopped by the casing 53 of the piercing device 50 for preventing the mouth 15 of the container 10 and/or the outlet tube 17 from being blocked by the hairs.

Accordingly, the container device in accordance with the present invention includes an insert or inner flexible film or membrane or envelope for receiving the pet cats and small dogs and for bathing or swimming purposes and for allowing the insert or flexible film or membrane or envelope to be easily removed or to be easily and quickly cleaned, and a piercing device for piercing the insert or flexible film or membrane or envelope after the bathing or swimming operations, and for allowing the water to be easily and quickly drained or discharged from the container, and for preventing the lower drain from being blocked by the hairs that are washed or removed from the pet cats and small dogs.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A container device comprising:
a container including a chamber formed therein and formed by an outer peripheral wall for receiving water therein, and including an outlet mouth,
a flexible insert engaged into said chamber of said container and having a compartment formed therein, and
means for selectively piercing said insert after use to allow said water to be discharged from said insert and said container.

2. The container device as claimed in claim 1, wherein said piercing means includes a piercing member for piercing said insert and for engaging into said mouth of said container and for allowing the water to be discharged from said insert after use.

3. The container device as claimed in claim 2, wherein said piercing means includes a pipe attached to said piercing member for engaging with said mouth of said container.

4. The container device as claimed in claim 3, wherein said piercing means includes a casing attached to said pipe, and said casing includes a plurality of orifices formed therein for water discharging purposes.

5. The container device as claimed in claim 4, wherein said piercing means includes at least one fin extended outwardly from said casing.

6. The container device as claimed in claim 4, wherein said piercing means includes a partition provided between said casing and said pipe for engaging with said insert.

7. The container device as claimed in claim 1, wherein said container includes a valve device attached to said outlet mouth of said container to control the water to flow out through said outlet mouth of said container.

8. The container device as claimed in claim 7, wherein said valve device includes am outlet tube attached to said outlet mouth of said container, and a valve member engaged in said outlet tube of said valve device.
